(19) United States
(12) Patent Application Publication
(10) Pub. No.: US 2011/0300367 A1
(43) Pub. Date: Dec. 8, 2011

(54) Optical Fiber With Photoacid Coating

(76) Inventor: Ching-Kee Chien, Horseheads, NY (US)

(21) Appl. No.: 13/151,869

(22) Filed: Jun. 2, 2011

Related U.S. Application Data
(60) Provisional application No. 61/352,124, filed on Jun. 7, 2010.

(51) Int. Cl. B32B 5/02; D02G 3/36; C09D 4/02

(52) U.S. Cl. 428/221; 522/182; 522/28; 522/11; 522/25; 522/29; 522/174; 522/175; 428/392; 428/389

(57) ABSTRACT

Disclosed is a composition that includes a photo-curable base composition that contains one or more acrylate-containing compounds; a photoinitiator that activates polymerization of the photo-curable base composition upon exposure to light of a suitable wavelength; and a photo-acid generating compound that liberates an acid group following exposure to the light of the suitable wavelength. Optical fibers that include the cured product of this composition demonstrate enhanced fatigue resistance, extending lifetime in transient, very small bend applications. Optical fiber ribbons that contain these optical fibers are also disclosed.

### CROSS-REFERENCE TO RELATED APPLICATIONS

This application claims the benefit of priority under 35 U.S.C. §119 of U.S. Provisional Application Ser. No. 61/352,124 filed on Jun. 7, 2010 entitled, “Optical Fiber Having Coating That Enhances Fiber Fatigue Resistance”, the content of which is relied upon and incorporated herein by reference in its entirety.

### FIELD

The present invention relates generally to optical fiber and optical fiber coating formulations that include a photoacid generator, which can enhance fiber fatigue resistance for the period of application under transient, very small bends.

### BACKGROUND

As optical fiber applications extend to communication between components inside computers and between computer peripherals, the deployment of optical fiber becomes more challenging. Because of limited space inside a computer, optical fiber can be sharply bent to a small radius and the generated bending stress can be very high. In particular, in consumer electronic applications fiber will be expected to survive extremely tight bends (<3 mm radius) for short periods of time. Under such extreme stress conditions it is beneficial to rely, besides good glass strength distribution, on enhanced fatigue resistance of the fiber.

Optical fiber strength degradation, or rather its resistance to such degradation, is one of the important parameters to estimate the lifetime of an optical fiber under stress. The measurement is carried out by a 2-point bend or a 0.5-meter tensile test, according to the Electronic Industries Alliance/Telecommunications Industry Association (“EIA/TIA”) FOTP-28 or the International Electrotechnical Commission (“IEC”) IEC 60793-1-33 dynamic tensile strength test methods. The testing can be carried out at multiple strain rates at various stress conditions (e.g., elevated temperature and humidity) designed to replicate long term aging. These tests allow for the calculation of the dynamic fatigue parameter, n_{d}. Change in n_{d} has little impact on long term reliability at larger bend radii, however, for fiber experiencing transient, very small (≦3 mm radius) bends, the increased fatigue resistance may substantially extend the lifetime of the fiber, such as from minutes to days. Many commercial optical fibers are typically characterized by an n_{d} value of about 18 to about 20. One approach for increasing the n_{d} value is to utilize a thin layer of titania on the glass cladding, as exemplified by the Corning Incorporated Titan® fiber, which has an n_{d} value between about 25 to about 30. It would be desirable to identify novel coating additives that can complement the glass in increasing the nd value of the fiber and being able to withstand transient bends of very small (≦3 mm) radius.

### SUMMARY

A first aspect of the disclosure relates to a composition that includes: a photo-curable base composition that contains one or more acrylate-containing compounds; a photoinitiator that activates polymerization of the photo-curable base composition upon exposure to light of a suitable wavelength; and a photo-acid generating compound that liberates an acid group following exposure to said light of the suitable wavelength.

A second aspect of the disclosure relates to an optical fiber that includes a glass fiber and a coating formed of the composition according to the first aspect of the invention, which coating substantially encapsulates the glass fiber.

A third aspect of the disclosure relates to an optical fiber ribbon that includes a plurality of optical fibers according to the second aspect of the invention.

A fourth aspect of the disclosure relates to methods of preparing optical fibers in accordance with the present invention. These methods involve encapsulating a glass fiber with a coating that is the cured product of a composition according to the first aspect of the invention, and then encapsulating the coated glass fiber with one or more additional coatings.

As demonstrated in the accompanying Examples, optical fibers disclosed herein are characterized by enhanced fatigue resistance n_{d}. As used herein, enhanced fatigue resistance refers to an optical fiber that possesses a higher dynamic fatigue parameter (n_{d}). The dynamic fatigue parameter, n_{d}, is determined by measuring the fiber strength according to the IEC 2-point bend test method at the following four strain rates: 1000 micron/second, 100 micron/second, 10 micron/second, and 1 micron/second. The median failure stress will vary with the strain rate, and the dynamic fatigue parameter can be calculated from the slope of the line plotting the strength versus the strain rate in logarithmic scale.

Additional features and advantages will be set forth in the detailed description which follows, and in part will be readily apparent to those skilled in the art from that description or recognized by practicing the disclosure as described herein, including the detailed description which follows, the claims, as well as the appended drawings.

It is to be understood that both the foregoing general description and the following detailed description are merely exemplary, and are intended to provide an overview or framework for understanding the nature and character of the invention as it is claimed. The accompanying drawings are included to provide further understanding, and are incorporated in and constitute a part of this specification. The drawings illustrate various embodiments of the disclosure and together with the description serve to explain the principles and operation of the invention.

### BRIEF DESCRIPTION OF THE DRAWINGS

FIG. 1 is a cross-sectional view of an optical fiber according to one embodiment disclosed herein. The fiber includes a coating that encapsulates the glass fiber, as well as two additional coatings that serve the purpose of the traditional primary and secondary coatings that are used in two-coating systems.

FIG. 2 is a cross-section view of an optical fiber ribbon that includes a total of twelve optical fibers that are encapsulated by a ribbon matrix. Although twelve optical fibers are shown, the ribbon can contain any plurality of optical fibers.

FIG. 3 is a schematic diagram illustrating a method of manufacturing an optical fiber as disclosed herein.

### DETAILED DESCRIPTION

The present disclosure relates to a novel coating compositions, optical fibers that possess the coating formulation, as well as their methods of manufacture and use within optical fiber ribbons/cables and telecommunication systems.

The coating compositions include a photo-curable base composition that contains one or more acrylate-containing compounds, a photoinitiator that activates polymerization of the photo-curable base composition upon exposure to light of a suitable wavelength, and a photo-acid generating (“PAG”) compound that liberates an acid group following exposure to said light of the suitable wavelength.

The photo-curable base composition is typically crosslinked during the photo-initiated curing process. As discussed in greater detail below, these coatings may be formed of one or more oligomers or polymers, one or more monomers, and one or more optional additives.

Importantly, the photo-curable base composition is substantially free of functional groups, such as epoxy groups or vinyl ether groups, whose cross-linking can be catalyzed by labile acid groups from the PAG compound. By “substantially free”, it is intended that the photo-curable base composition contains less than 5 weight percent of the functional groups whose cross-linking can be catalyzed by labile acid groups from the PAG compound, preferably less than 2.5 weight percent, and most preferably less than 0.5 weight percent or even completely absent.

Although acrylate-functional groups are preferred, the photo-curable base composition may optionally contain one or more urethanes, acrylamides, N-vinyl amides, styrenes, vinyl esters, or combinations thereof.

As used herein, the weight percent of a particular component refers to the amount introduced into the bulk photo-curable base composition excluding any additives. The amount of additives that are introduced into the bulk composition to produce a composition of the present invention is listed in parts per hundred (based on weight percent). For example, an oligomer, monomer, and photoinitiator are combined to form the bulk composition such that the total weight percent of these components equals 100 percent. To this bulk composition, an amount of a particular additive, for example 1 part per hundred, is introduced in excess of the 100 weight percent of the bulk composition.

The oligomer component, if present, is preferably an ethylenically unsaturated oligomer, more preferably a (meth)acrylate oligomer. The term (meth)acrylate is intended to encompass both acrylates and methacrylates, as well as combinations thereof. The (meth)acrylate terminal groups in such oligomers may be provided by a monohydric poly(meth)acrylate capping component, or by a mono(meth)acrylate capping component such as 2-hydroxyethyl acrylate, in the known manner.

Urethane oligomers are conventionally provided by reacting an aliphatic or aromatic diisocyanate with a dihydric polyether or polyester, most typically a polyoxyalkylene glycol such as a polyethylene glycol. Such oligomers typically have 4-10 urethane groups and may be of high molecular weight, e.g., 2000-8000. However, lower molecular weight oligomers, having molecular weights in the 500-2000 range, may also be used. U.S. Pat. No. 4,608,409 to Coady et al. and U.S. Pat. No. 4,609,718 to Bishop et al., each of which is hereby incorporated by reference, describe such syntheses in detail.

When it is desirable to employ moisture-resistant oligomers, they may be synthesized in an analogous manner, except that the polar polyether or polyester glycols are avoided in favor of predominantly saturated and predominantly nonpolar aliphatic diols. These diols include, for example, alkane or alkylene diols of from 2-250 carbon atoms and, preferably, are substantially free of ether or ester groups. The ranges of oligomer viscosity and molecular weight obtainable in these systems are similar to those obtainable in unsaturated, polar oligomer systems, such that the viscosity and coating characteristics thereof can be kept substantially unchanged. The reduced oxygen content of these coatings has been found not to unacceptably degrade the adherence characteristics of the coatings to the surfaces of the glass fibers being coated.

As is well known, polyurea components may be incorporated in oligomers prepared by these methods, simply by substituting diamines or polyamines for diols or polyols in the course of synthesis. The presence of minor proportions of polyurea components in the present coating systems is not considered detrimental to coating performance, provided only that the diamines or polyamines employed in the synthesis are sufficiently non-polar and saturated as to avoid compromising the moisture resistance of the system.

Suitable ethylenically unsaturated oligomers include polyether urethane acrylate oligomers (CN986 available from Sartomer Company, Inc., West Chester, Pa.) and BR 3731, BR 3741, and STC3-149 available from Bomar Specialty Co., Winstead, Conn.), acrylate oligomers based on tris(hydroxyethyl)isocyanurate, (meth)acrylated acrylic oligomers, polyester urethane acrylate oligomers (CN966 and CN973 available from Sartomer Company, Inc.; and BR7432 available from Bomar Specialty Co.), polyurea urethane acrylate oligomers (e.g., oligomers disclosed in U.S. Pat. Nos. 4,690,502 and 4,798,852 to Zimmerman et al., U.S. Pat. No. 4,609,718 to Bishop, and U.S. Pat. No. 4,629,287 to Bishop et al., each of which is hereby incorporated by reference in its entirety), polyether acrylate oligomers (Genomer 3456 available from Rahn A G, Zurich, Switzerland), polyester acrylate oligomers (Ebecryl 80, 584, and 657 available from Cytec Industries Inc., Atlanta, Ga.), polyurea acrylate oligomers (e.g., oligomers disclosed in U.S. Pat. Nos. 4,690,502 and 4,798,852 to Zimmerman et al., U.S. Pat. No. 4,609,718 to Bishop, and U.S. Pat. No. 4,629,287 to Bishop et al., each of which is hereby incorporated by reference in its entirety), hydrogenated polybutadiene oligomers (Echo Resin MBNX available from Echo Resins and Laboratory, Versailles, Mo.), and combinations thereof.

Alternatively, the oligomer component can also include a non-reactive oligomer component as described in U.S. Application Publ. No. 20070100039 to Schissel et al., which is hereby incorporated by reference in its entirety. These non-reactive oligomer components can be used to achieve high modulus coatings that are not excessively brittle. These non-reactive oligomer materials are particularly preferred for the higher modulus coatings.

The oligomer component(s) are typically present in the coating composition in amounts of about 0 to about 90 percent by weight, more preferably between about 25 to about 75 percent by weight, and most preferably between about 40 to about 65 percent by weight.

The coating composition(s) can also include one or more polymer components either as a replacement of the oligomer component or in combination with an oligomer component. The use of polymer components is described, for example, in U.S. Pat. No. 6,869,981 to Fewkes et al., which is hereby incorporated by reference in its entirety.

The polymer can be a block copolymer including at least one hard block and at least one soft block, wherein the hard block has a T_{g} greater than the T_{g} of the soft block. Preferably the soft block backbone is aliphatic. Suitable aliphatic backbones include poly(butadiene), polyisoprene, polyethylene/butylene, polyethylene/propylene, and diol blocks. One example of a block copolymer is a di-block copolymer having the general structure of A-B. A further example of a suitable copolymer is a tri-block having the general structure A-B-A. Preferably the mid block has a molecular weight of at least about 10,000, more preferably more than about 20,000, still more preferably more than about 50,000, and most preferably more than about 100,000. In the case of a tri-block copolymer (A-B-A), the mid-block (B, such as butadiene in a SBS copolymer as defined herein) has a T_{g} of less than about 20° C. An example of a multi-block copolymer, having more than three blocks includes a thermoplastic polyurethane (TPU). Sources of TPU include BASF, B. F. Goodrich, and Bayer. The block copolymer may have any number of multiple blocks.

The polymer component may or may not be chemically cross-linked when cured. Preferably, the polymer is a thermoplastic elastomer polymer. Preferably, the polymer component has at least two thermoplastic terminal end blocks and an elastomeric backbone between two of the end blocks, such as styrenic block copolymers. Suitable thermoplastic terminal end block materials include polystyrene and polymethyl methacrylate. Suitable mid blocks include ethylene propylene diene monomer (“EPDM”) and ethylene propylene rubber. The elastomeric mid-block can be polybutadiene, polyisoprene, polyethylene/butylene, and polyethylene/propylene.

Examples of commercially available styrenic block copolymers are KRATON™ (Kraton Polymers, Houston Tex.), CALPRENE™ (Repsol Quimica S. A. Corporation, Spain), SOLPRENE™ (Phillips Petroleum Co), STEREON™ (Firestone Tire & Rubber Co., Akron, Ohio), KRATON™ D1101, which is a styrene-butadiene linear block copolymer (Kraton Polymers), KRATON™ D1193, which is a styrene-isoprene linear block copolymer (Kraton Polymers), KRATON™ FG1901X, which is a styrene-ethylene-butylene block polymer grafted with about 2% w maleic anhydride (Kraton Polymers), KRATON™ D1107, which is a styrene-isoprene linear block copolymer (Kraton Polymers) and HARDMAN ISOLENE™ 400, which is a liquid polyisoprene (Elementis Performance Polymers, Belleville, N.J.).

The polymer component(s), when used, are typically present in the coating composition in amounts of about 5 to about 90 percent by weight, preferably from about 10 percent by weight up to about 30 percent by weight, and most preferably from about 12 percent by weight to about 20 percent by weight.

The one or more monomer components are preferably ethylenically unsaturated. Suitable functional groups for ethylenically unsaturated monomers used in accordance with the present invention include, without limitation, acrylates, methacrylates, acrylamides, N-vinyl amides, styrenes, and combinations thereof (i.e., for polyfunctional monomers). Of these, the (meth)acrylate monomers are usually preferred.

Generally, a lower molecular weight (i.e., about 120 to 600) liquid (meth)acrylate-functional monomer is added to the formulation to provide the liquidity needed to apply the coating composition with conventional liquid coating equipment. Typical acrylate-functional liquids in these systems include monofunctional and polyfunctional acrylates (i.e., monomers having two or more acrylate functional groups). Illustrative of these polyfunctional acrylates are the difunctional acrylates, which have two functional groups; the trifunctional acrylates, which have three functional groups; and the tetrafunctional acrylates, which have four functional groups. Monofunctional and polyfunctional methacrylates may be employed together.

When it is desirable to utilize moisture-resistant components, the monomer component will be selected on the basis of its compatibility with the selected moisture-resistance oligomer. Not all such liquid monomers may be successfully blended and co-polymerized with the moisture-resistant oligomers, because such oligomers are highly non-polar. For satisfactory coating compatibility and moisture resistance, it is desirable to use a liquid acrylate monomer component comprising a predominantly saturated aliphatic mono- or di-acrylate monomer or alkoxy acrylate monomers.

Suitable polyfunctional ethylenically unsaturated monomers include, without limitation, alkoxylated bisphenol A diacrylates such as ethoxylated bisphenol A diacrylate with ethoxylation being 2 or greater, preferably ranging from 2 to about 30 (SR349 and SR601 available from Sartomer Company, Inc.; and Photomer 4025 and Photomer 4028, available from Cognis Corp., Ambler, Pa.), and propoxylated bisphenol A diacrylate with propoxylation being 2 or greater, preferably ranging from 2 to about 30; methylolpropane polyacrylates with and without alkoxylation such as ethoxylated trimethylolpropane triacrylate with ethoxylation being 3 or greater, preferably ranging from 3 to about 30 (Photomer 4149 available from Cognis Corp., and SR499 available from Sartomer Company, Inc.), propoxylated trimethylolpropane triacrylate with propoxylation being 3 or greater, preferably ranging from 3 to 30 (Photomer 4072 available from Cognis Corp.; and SR492 available from Sartomer Company, Inc.), and ditrimethylolpropane tetraacrylate (Photomer 4355 available from Cognis Corp.); alkoxylated glyceryl triacrylates such as propoxylated glyceryl triacrylate with propoxylation being 3 or greater (Photomer 4096 available from Cognis Corp.; and SR9020 available from Sartomer Company, Inc.); erythritol polyacrylates with and without alkoxylation, such as pentaerythritol tetraacrylate (SR295 available from Sartomer Company, Inc.), ethoxylated pentaerythritol tetraacrylate (SR494 available from Sartomer Company, Inc.), and dipentaerythritol pentaacrylate (Photomer 4399 available from Cognis Corp.; and SR399 available from Sartomer Company, Inc.); isocyanurate polyacrylates formed by reacting an appropriate functional isocyanurate with an acrylic acid or acryloyl chloride, such as tris-(2-hydroxyethyl) isocyanurate triacrylate (SR368 available from Sartomer Company, Inc.) and tris-(2-hydroxyethyl) isocyanurate diacrylate; alcohol polyacrylates with and without alkoxylation such as tricyclodecane dimethanol diacrylate (CD406 available from Sartomer Company, Inc.) and ethoxylated polyethylene glycol diacrylate with ethoxylation being 2 or greater, preferably ranging from about 2 to 30; epoxy acrylates formed by adding acrylate to bisphenol A diglycidylether and the like (Photomer 3016 available from Cognis Corp.); and single and multi-ring cyclic aromatic or non-aromatic polyacrylates such as dicyclopentadiene diacrylate.

It may also be desirable to use certain amounts of monofunctional ethylenically unsaturated monomers, which can be introduced to influence the degree to which the cured product absorbs water, adheres to other coating materials, or behaves under stress. Exemplary monofunctional ethylenically unsaturated monomers include, without limitation, hydroxyalkyl acrylates such as 2-hydroxyethyl-acrylate, 2-hydroxypropyl-acrylate, and 2-hydroxybutyl-acrylate; long- and short-chain alkyl acrylates such as methyl acrylate, ethyl acrylate, propyl acrylate, isopropyl acrylate, butyl acrylate, amyl acrylate, isobutyl acrylate, t-butyl acrylate, pentyl acrylate, isoamyl acrylate, hexyl acrylate, heptyl acrylate, octyl acrylate, isooctyl acrylate (SR440 available from Sartomer Company, Inc. and Ageflex FA8 available from CPS Chemical Co.), 2-ethylhexyl acrylate, nonyl acrylate, decyl acrylate, isodecyl acrylate (SR395 available from Sartomer Company, Inc.; and Ageflex FA10 available from CPS Chemical Co.), undecyl acrylate, dodecyl acrylate, tridecyl acrylate (SR489 available from Sartomer Company, Inc.), lauryl acrylate (SR335 available from Sartomer Company, Inc., Ageflex FA12 available from CPS Chemical Co., Old Bridge, N.J.), and Photomer 4812 available from Cognis Corp.), octadecyl acrylate, and stearyl acrylate (SR257 available from Sartomer Company, Inc.); aminoalkyl acrylates such as dimethylaminoethyl acrylate, diethylaminoethyl acrylate, and 7-amino-3,7-dimethyloctyl acrylate; alkoxyalkyl acrylates such as butoxylethyl acrylate, phenoxyethyl acrylate (SR339 available from Sartomer Company, Inc., Ageflex PEA available from CPS Chemical Co., and Photomer 4035 available from Cognis Corp.), phenoxyglycidyl acrylate (CN131 available from Sartomer Company, Inc.), lauryloxyglycidyl acrylate (CN130 available from Sartomer Company, Inc.), and ethoxyethoxyethyl acrylate (SR256 available from Sartomer Company, Inc.); single and multi-ring cyclic aromatic or non-aromatic acrylates such as cyclohexyl acrylate, benzyl acrylate, dicyclopentadiene acrylate, dicyclopentanyl acrylate, tricyclodecanyl acrylate, bornyl acrylate, isobornyl acrylate (SR423 and SR506 available from Sartomer Company, Inc., and Ageflex IBOA available from CPS Chemical Co.), tetrahydrofurfuryl acrylate (SR285 available from Sartomer Company, Inc.), caprolactone acrylate (SR495 available from Sartomer Company, Inc.; and Tone M100 available from Dow Chemical, Midland, Mich.), and acryloylmorpholine; alcohol-based acrylates such as polyethylene glycol monoacrylate, polypropylene glycol monoacrylate, methoxyethylene glycol acrylate, methoxypolypropylene glycol acrylate, methoxypolyethylene glycol acrylate, ethoxydiethylene glycol acrylate, and various alkoxylated alkylphenol acrylates such as ethoxylated (4) nonylphenol acrylate (Photomer 4003 available from Cognis Corp.; and SR504 available from Sartomer Company, Inc.) and propoxylatednonylphenol acrylate (Photomer 4960 available from Cognis Corp.); acrylamides such as diacetone acrylamide, isobutoxymethyl acrylamide, N,N′-dimethyl-aminopropyl acrylamide, N,N-dimethyl acrylamide, N,N-diethyl acrylamide, and t-octyl acrylamide; vinylic compounds such as N-vinylpyrrolidone and N-vinylcaprolactam (both available from International Specialty Products, Wayne, N.J.); and acid esters such as maleic acid ester and fumaric acid ester.

The monomer component(s) are typically present in the coating composition in amounts of about 10 to about 90 percent by weight, more preferably between about 20 to about 60 percent by weight, and most preferably between about 25 to about 50 percent by weight.

The photoinitiator for the photo-curable base composition is preferably one or more of the known ketonic photoinitiators and/or phosphine oxide photoinitiators. When used in the compositions of the present invention, the photoinitiator is present in an amount sufficient to provide rapid ultraviolet curing. Generally, this includes between about 0.5 to about 10.0 percent by weight, more preferably between about 1.5 to about 7.5 percent by weight. Where lower degrees of cure are desired, or no curing is required, the amount of photoinitiator employed in a particular composition can be less than 0.5 percent by weight.

The photoinitiator, when used in a small but effective amount to promote radiation cure, should provide reasonable cure speed without causing premature gelation of the coating composition. A desirable cure speed is any speed sufficient to cause substantial curing of the coating materials. As measured in a dose versus modulus curve, a cure speed for coating thicknesses of about 25-35 μm is, e.g., less than 1.0 J/cm², preferably less than 0.5 J/cm².

Suitable photoinitiators include, without limitation, 1-hydroxycyclohexylphenyl ketone (Irgacure 184 available from BASF, Hawthorne, N.Y.), (2,6-dimethoxybenzoyl)-2,4,4-trimethylpentyl phosphine oxide (commercial blends Irgacure 1800, 1850, and 1700 available from BASF), 2,2-dimethoxyl-2-phenyl acetophenone (Irgacure 651, available from BASF), bis(2,4,6-trimethyl benzoyl)phenyl-phosphine oxide (Irgacure 819, available from BASF), (2,4,6-trimethylbenzoyl)diphenyl phosphine oxide (Lucerin TPO available from BASF, Munich, Germany), ethoxy (2,4,6-trimethylbenzoyl)phenyl phosphine oxide (Lucerin TPO-L from BASF), and combinations thereof.

The photo-acid generating compound is a compound that, upon exposure to the light used to cure the composition, is cleaved to release an acidic compound. The photo-acid generating compound is preferably one that does not reactively cross-link into the polymerization product of the photo-curable base composition, either before or after cleavage.

One suitable class of PAG compounds is a traditional cationic photoinitiator that is used to promote cross-linking of epoxy-containing compounds. Importantly, these PAG compounds are unable to promote cross-linking of acrylate containing compounds present in the photo-curable base composition of the present invention.

Cationic photoinitiators suitable for use in the present invention include onium salts such as those that contain halogen complex anions of divalent to heptavalent metals or non-metals, for example, Sb, Sn, Fe, Bi, Al, Ga, In, Ti, Zr, Sc, Cr, Hf, and Cu as well as B, P, and As. Examples of suitable onium salts are diaryl-diazonium salts and onium salts of group Va and B, Ia and B and I of the Periodic Table; for example, halonium salts, quaternary ammonium, phosphonium and arsonium salts, aromatic sulfonium salts, sulfoxonium salts, and selenium salts. Onium salts have been described in the literature such as in U.S. Pat. Nos. 4,442,197; 4,603,101; and 4,624,912, each of which is hereby incorporated by reference in its entirety.

The onium salt can be one that releases HF or fluoride, or one that does not release HF or fluoride. Examples of onium salts that do not release HF or fluoride include, without limitation, iodonium salts such as iodonium methide, iodonium —C(SO₂CF₃)₃, iodonium —B(C₆F₅), and iodonium —N(SO₂CF₃)₂.

One class of materials particularly useful as the anionic portion of the onium salt employed in the present invention may be generally classified as fluorinated (including highly fluorinated and perfluorinated) tris alkyl- or arylsulfonyl methides and corresponding bis alkyl- or arylsulfonyl imides of the type disclosed in U.S. Pat. No. 6,895,156 to Walker, Jr., et al., which is hereby incorporated by reference in its entirety. Specific examples of anions useful in the practice of the present invention include, without limitation: (C₂F₅SO₂)₂N—, (C₄F₉SO₂)₂N—, (C₈F₁₇SO₂)₃C—, (CF₃SO₂)₂N—, (C₄F₉SO₂)₃C—, (CF₃SO₂)₂(C₄F₉SO₂)C—, (CF₃SO₂)(C₄F₉SO₂)N—, [(CF₃)₂N]C₂F₄SO₂N—, [(CF₃)₂N]C₂F₄SO₂C—, (SO₂CF₃)₂(3,5-bis(CF₃)C₆H₃)SO₂N—, SO₂CF₃, and the like. Anions of this type, and methods for making them, are described in U.S. Pat. Nos. 4,505,997; 5,021,308; 4,387,222; 5,072,040; 5,162,177; and 5,273,840, and in Turowsky et al., Inorg. Chem., 27:2135-2137 (1988), each of which is hereby incorporated by reference in its entirety. Turowsky et al. describe the direct synthesis of the (CF₃SO₂)C— anion from CF₃SO₂F and CH₃MgCl in 20% yield based on CF₃SO₂F (19% based on CH₃MgCl). U.S. Pat. No. 5,554,664, which is hereby incorporated by reference in its entirety, describes an improved method for synthesizing iodonium methide.

Salts of the above described anions may be activated by radiation. Suitable salts having such non-nucleophilic anions for use as a PAG in the composition of the present invention are those salts that upon application of sufficient electromagnetic radiation having a wavelength from about 200 to 800 nm will generate a compound having an acidic group.

One preferred cationic PAG is (4-methylphenyl)[4-(2-methylpropyl)phenyl]iodonium PF₆, which is commercially available under the tradename Irgacure 250 (BASF).

Another suitable type of PAG compound is a non-ionic photoacid generator. Exemplary classes of non-ionic PAGs include, without limitation, imidosulfonates; oxime sulfonates; N-oxyimidosulfonates; disulfones including α,α-methylenedisulfones and disulfonehydrazines; diazosulfones; N-sulfonyloxyimides; nitrobenzyl compounds; and halogenated compounds.

Exemplary N-sulfonyloxyimide PAGs include those disclosed in PCT Application Publ. No. WO94/10608, which is hereby incorporated by reference in its entirety.

Exemplary nitrobenzyl-based PAGs include those disclosed in EP Application No. 0717319 A1, which is hereby incorporated by reference in its entirety.

Exemplary disulfone PAGs include those disclosed in EP Application No. 0708368 A1, which is hereby incorporated by reference in its entirety.

Exemplary imidosulfonate PAGs include those disclosed in U.S. Application Publ. No. 20080220597, which is hereby incorporated by reference in its entirety.

Exemplary oxime sulfonate and N-oxyimidosulfonate PAG groups include those disclosed in U.S. Pat. No. 6,482,567, which is hereby incorporated by reference in its entirety.

Exemplary diazosulfone PAGs include those disclosed in European Patent Application 0708368 A1 and U.S. Pat. No. 5,558,976, each of which is hereby incorporated by reference in its entirety.

One preferred non-ionic PAG compound is 8-[2,2,3,3,4,4,5,5-octafluoro-1-(nonafluorobutylsulfonyloxyimino)-pentyl]-fluoranthene, which is commercially available under the tradename PAG121(BASF).

Yet another class of PAGs includes iron arene complexes. Upon irradiation, the iron arene complex defragments to a coordinatively unsaturated, iron containing intermediate, which has the characteristics of a Lewis acid. One preferred iron arene complex is η⁵-2,4-cyclopentadien-1-yl)[(1,2,3,4,5,6-ii)-(1-methyl ethyl)benzene]-iron(+)-hexafluorophosphate, which is commercially available under the tradename Irgacure 261 (BASF).

The PAG compound is present in an amount of about 0.1 pph up to about 10 pph, more preferably about 0.5 pph up to about 8 pph, most preferably about 1 pph up to about 7 pph.

The photo-curable base composition can optionally include one or more additional additives. These additives include, without limitation, catalysts, carrier surfactants, tackifiers, adhesion promoters, antioxidants, photosensitizers, stabilizers, reactive diluents, lubricants, optical brighteners, and low molecular weight non-crosslinking resins. Some additives, for example, catalysts, reactive surfactants, and optical brighteners, can operate to control the polymerization process, thereby affecting the physical properties (e.g., modulus, glass transition temperature) of the polymerization product formed from the coating composition. Others can affect the integrity of the polymerization product of the coating composition (e.g., protect against de-polymerization or oxidative degradation).

An exemplary catalyst is a tin-catalyst, which is used to catalyze the formation of urethane bonds in some oligomer components. Whether the catalyst remains as an additive of the oligomer component or additional quantities of the catalyst are introduced into the composition of the present invention, the presence of the catalyst can act to stabilize the oligomer component in the composition.

Suitable carriers, more specifically carriers which function as reactive surfactants, include polyalkoxypolysiloxanes. Preferred carriers are available from Goldschmidt Chemical Co. (Hopewell, Va.) under the tradename TEGORAD 2200 and TEGORAD 2700 (acrylated siloxane). These reactive surfactants may be present in a preferred amount between about 0.01 to about 5 pph, more preferably about 0.25 to about 3 pph.

Other classes of suitable carriers are polyols and non-reactive surfactants. Examples of suitable polyols and non-reactive surfactants include the polyol Aclaim 3201 (poly(ethylene oxide-co-propylene oxide)) available from Lyondel (formerly known as Arco Chemicals) (Newtowne Square, Pa.), and the non-reactive surfactant Tegoglide 435 (polyalkoxy-polysiloxane) available from Goldschmidt Chemical Co. The polyol or non-reactive surfactants may be present in a preferred amount between about 0.01 pph to about 10 pph, more preferably about 0.05 to about 5 pph, most preferably about 0.1 to about 2.5 pph.

Suitable carriers may also be ambiphilic molecules. An ambiphilic molecule is a molecule that has both hydrophilic and hydrophobic segments. The hydrophobic segment may alternatively be described as a lipophilic (fat/oil loving) segment. A tackifier is an example of one such ambiphilic molecule. A tackifier is a molecule that can modify the time-sensitive rheological property of a polymer product. In general a tackifier additive will make a polymer product act stiffer at higher strain rates or shear rates and will make the polymer product softer at low strain rates or shear rates. A tackifier is an additive that is commonly used in the adhesives industry, and is known to enhance the ability of a coating to create a bond with an object that the coating is applied upon.

A preferred tackifier is Uni-tac® R-40 (hereinafter “R-40”) available from International Paper Co. (Purchase, N.Y.). R-40 is a tall oil rosin, which contains a polyether segment, and is from the chemical family of abietic esters. Preferably, the tackifier is present in the composition in an amount between about 0.01 to about 10 pph, more preferably in the amount between about 0.05 to about 5 pph. A suitable alternative tackifier is the Escorez series of hydrocarbon tackifiers available from Exxon. For additional information regarding Escorez tackifiers, see U.S. Pat. No. 5,242,963 to Mao, which is hereby incorporated by reference in its entirety. The aforementioned carriers may also be used in combination.

Any suitable adhesion promoter can be employed. Examples of a suitable adhesion promoter include organofunctional silanes, titanates, zirconates, and mixtures thereof. Preferably, the adhesion promoter is a poly(alkoxy)silane, most preferably bis(trimethoxysilylethyl)benzene. Suitable alternative adhesion promoters include 3-mercaptopropyltrimethoxysilane (3-MPTMS, available from United Chemical Technologies (Bristol, Pa.); also available from Gelest (Morrisville, Pa.)), 3-acryloxypropyltrimethoxysilane (available from Gelest), and 3-methacryloxypropyltrimethoxysilane (available from Gelest), and bis(trimethoxysilylethyl)benzene (available from Gelest). Other suitable adhesion promoters are described in U.S. Pat. Nos. 4,921,880 and 5,188,864 to Lee et al., each of which is hereby incorporated by reference. The adhesion promoter, if present, is used in an amount between about 0.1 to about 10 pph, more preferably about 0.25 to about 3 pph.

Any suitable antioxidant can be employed. Preferred antioxidants include, without limitation, bis hindered phenolic sulfide or thiodiethylene bis(3,5-di-tert-butyl)-4-hydroxyhydrocinnamate (Irganox 1035, available from BASF). The antioxidant, if present, is used in an amount between about 0.1 to about 3 pph, more preferably about 0.25 to about 2 pph.

Any suitable photosensitizer can be employed to promote activity of the PAG. The photosensitizer allows for the use of broad-wavelength photoinitiation light energy more efficiently. The photosensitizer should be capable of absorbing light at the wavelength(s) used for the selected photoinitiator(s) and then transfer the energy to the PAG to induce generation of the acidic compound. The photosensitizer can be used in an amount of about 0.05 pph up to about 1 pph, preferably about 0.1 pph up to about 0.5 pph.

One class of photosensitizer that can be used is a free radical photoinitiator, such as isopropylthioxanthone (“ITX”), which is commercially available under the tradename Darocur® ITX (BASF).

Any suitable stabilizer can be employed. One preferred stabilizer is a tetrafunctional thiol, e.g., pentaerythritoltetrakis(3-mercaptopropionate) from Sigma-Aldrich (St. Louis, Mo.). The stabilizer, if present, is used in an amount between about 0.01 to about 1 pph, more preferably about 0.01 to about 0.2 pph.

Any suitable optical brightener can be employed. Exemplary optical brighteners include, without limitation, Uvitex OB, a 2,5-thiophenediylbis(5-tert-butyl-1,3-benzoxazole) (BASF); Blankophor KLA, available from Bayer; bisbenzoxazole compounds; phenylcoumarin compounds; and bis(styryl)biphenyl compounds. The optical brightener is desirably present in the composition at a concentration of about 0.003 to about 0.5 pph, more preferably about 0.005 to about 0.3 pph.

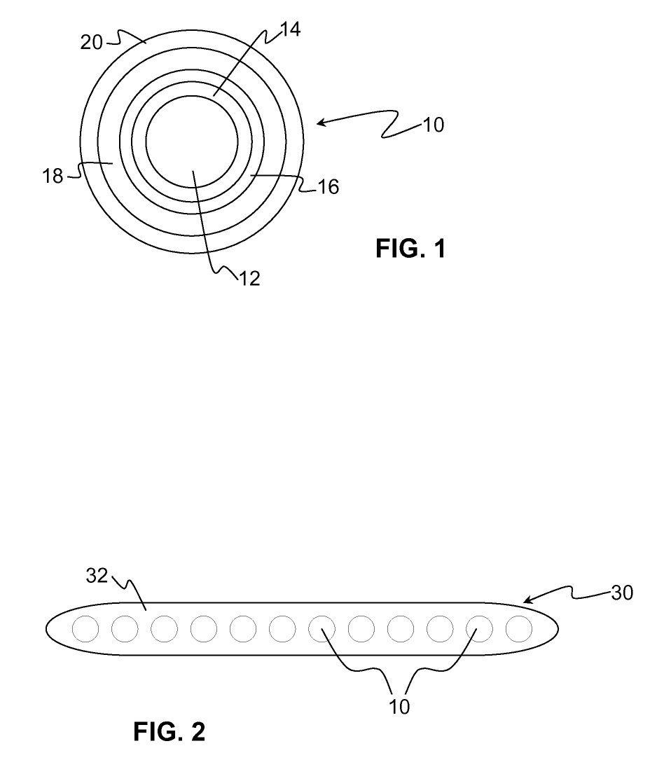

The photo-curable composition is intended to be used directly on an optical fiber core/cladding by applying the composition to the fiber so that it substantially encapsulates the glass fiber and then curing the same. Referring now to FIG. 1, an optical fiber 10 according to one embodiment of the present invention includes a fiber and a coating 16 of the invention that encapsulates the fiber. The optical fiber can optionally include or more additional coatings. As shown in FIG. 1, the optical fiber includes an intermediate coating 18 and an outer coating 20.

The fiber is typically formed of glass, primarily silica glass, and preferably includes both a glass core 12 and a glass coating known as a cladding layer 14. The glass fiber can be formed according to a number of processes known in the art. In many applications, the glass core and cladding layer have a discernable core-cladding boundary (as illustrated in FIG. 1). Alternatively, the core and cladding layer can lack a distinct boundary. One such glass fiber is a step-index fiber. Exemplary step-index fibers are described in U.S. Pat. Nos. 4,300,930 and 4,402,570 to Chang, each of which is hereby incorporated by reference in its entirety. Another such fiber is a graded-index fiber, which has a core whose refractive index varies with distance from the fiber center. A graded-index fiber is formed basically by diffusing the glass core and cladding layer into one another. Exemplary graded-index fibers are described in U.S. Pat. No. 5,729,645 to Garito et al., U.S. Pat. No. 4,439,008 to Joormann et al., U.S. Pat. No. 4,176,911 to Marcatili et al., and U.S. Pat. No. 4,076,380 to DiMarcello et al., each of which is hereby incorporated by reference in its entirety. The glass fiber may also be single- or multi-moded at the wavelength of interest, e.g., 1310 or 1550 nm. The optical fibers of the present invention can contain these or any other suitable core-cladding layer configuration now known or hereafter developed.

In one preferred embodiment, the cladding layer 14 includes an outer cladding layer doped with at least about 8 weight percent of titania, preferably greater than about 10 weight percent, and more preferably greater than about 12 weight percent. The dimension of the titania-doped cladding layer is preferably greater than 1 micron and less than 5 microns. Exemplary titania outer-clad fibers are described in U.S. Pat. No. 5,140,665 to Backer et al., which is hereby incorporated by reference in its entirety.

The glass fiber (core and cladding combined) typically has a total thickness of between about 70 to about 200 μm, preferably about 80 to about 200 μm, more preferably about 100 to about 145 μm.

Coating 16 is the innermost coating, and it serves the function of enhancing the fatigue-resistance of the fiber, as quantified by the value of n_{d}, which as noted above can be measured by the IEC dynamic fatigue test method. The optical fiber of the present invention has an increased n_{d} value relative to an otherwise identical fiber that lacks the coating 16.

Coating 16 preferably has a thickness of less than about 20 μm, less than about 12.5 μm, or even less than about 10 μm. More preferably, coating 16 is between about 2 and about 20 μm, between about 3 and about 15 μm, or between about 5 and about 12.5 μm.

Coating 16 preferably has a Young's modulus of greater than about 900 MPa, preferably greater than about 1200 MPa, and more preferably greater than about 1500 MPa. As used herein, the Young's modulus, elongation to break, and tensile strength of a coating material 16 is measured using a tensile testing instrument (e.g., a Sintech MTS Tensile Tester, or an Instron Universal Material Test System) on a sample of a material shaped as a cylindrical rod about 0.0225″ (571.5 μm) in diameter, with a gauge length of 5.1 cm, and a test speed of 2.5 cm/min. Yield stress can be measured on the rod samples at the same time as the Young's modulus, elongation to break, and tensile strength.

Coating 16 also has a fracture toughness (K_{1C}) of at least about 0.7 MPa·m^{1/2}, more preferably at least about 0.8 MPa·m^{1/2}, most preferably at least about 0.9 MPa·m^{1/2}. Fracture toughness is a property of a coating material that refers to its resistance to unstable, catastrophic crack growth. The fracture toughness of a material relates to the amount of energy required to propagate a crack in the material. As used herein, fracture toughness K_{ic} is measured on film samples, and is defined as:

K_{1C}=Yσ·√z,

where Y is a geometry factor, σ is the tensile strength (at break) of the film sample, and z is half of the notch length. Fracture toughness is measured on films having a center cut notch geometry as described, for example, in U.S. Pat. No. 7,715,675 to Fabian et al., which is hereby incorporated by reference in its entirety. The tensile strength (at break) of the film sample, σ, is measured using a tensile testing instrument (e.g., a Sintech MTS Tensile Tester, or an Instron Universal Material Test System), as described above. The tensile strength may be calculated by dividing the applied load at break by the cross-sectional area of the intact sample. A sample formula for calculation of tensile strength is also recited, for example, in U.S. Pat. No. 7,715,675 to Fabian et al., which is hereby incorporated by reference in its entirety.

Coating 16 also has a ductility of at least about 270 microns, more preferably at least about 300 microns, most preferably at least about 350 microns.

The sensitivity of the coating to handling and to the formation of defects is reflected by its ductility. Ductility is defined by the equation:

Ductility=(K_{1C}/yield stress)

Larger ductilities indicate reduced sensitivity of the coating to defects. As is familiar to the skilled artisan, for samples that exhibit strain softening, the yield stress is determined by the first local maximum in the stress vs. strain curve. More generally, the yield stress can be determined using the method given in ASTM D638-02, which is incorporated herein by reference. Physical properties such as Young's modulus, elongation to break, tensile strength, and yield stress are determined as an average of at least five samples.

Exemplary coating 16 formulations include about 10 weight percent of a polyether urethane acrylate oligomer (KWS 4131 from Bomar Specialty Co.), about 72 to about 82 weight percent ethoxylated (4) bisphenol A diacrylate monomer (Photomer 4028 from Cognis), about 5 weight percent bisphenol A diglycidyl diacrylate (Photomer 3016 from Cognis), optionally up to about 10 weight percent of a diacrylate monomer (Photomer 4002 from Cognis) or N-vinylcaprolactam, up to about 3 weight percent of a photoinitiator (Irgacure 184 from BASF, or Lucirin® TPO from BASF, or combination thereof), to which is added about 0.5 pph antioxidant (Irganox 1035 from BASF).

One preferred coating formulation for coating 16 includes 10 weight percent of a polyether urethane acrylate oligomer (KWS 4131), 82 weight percent ethoxylated (4) bisphenol A diacrylate monomer (Photomer 4028), 5 weight percent bisphenol A diglycidyl diacrylate (Photomer 3016), 1.5 weight percent Irgacure 184, 1.5 weight percent Lucirin TPO, 1.0 pph Irgacure 250, 0.5 pph Irganox 1035, 0.2 pph ITX, 1.0 pph (3-acryloxypropyl)-trimethoxysilane (Gelest).

Another preferred coating formulation for coating 16 includes 10 weight percent of a polyether urethane acrylate oligomer (KWS 4131), 82 weight percent ethoxylated (4) bisphenol A diacrylate monomer (Photomer 4028), 5 weight percent bisphenol A diglycidyl diacrylate (Photomer 3016), 1.5 weight percent Irgacure 184, 1.5 weight percent Lucirin TPO, 1.0 pph PAG121 (BASF), 0.5 pph Irganox 1035, 0.2 pph ITX, 1.0 pph (3-acryloxypropyl)-trimethoxysilane (Gelest).

These preferred compositions afford a coating that is characterized by a Young's modulus of about 1658.32 (±46.41) MPa, a yield stress of 41.03 (±0.70) MPa, a fracture toughness of about 0.8150 (±0.0853) MPa·m^{1/2}, a ductility of about 395 microns, and a T_{g} of about 55-58° C.

Coating 18 is an intermediate coating, and it serves the traditional role of a “primary” coating, which normally is applied directly to the glass fiber. Coating 18 is preferably formed from a soft crosslinked polymer material having a low Young's modulus (e.g., less than about 5 MPa at 25° C.) and a low T_{g} (e.g., less than about −10° C.). The Young's modulus is preferably less than about 3 MPa, more preferably between about 0.1 MPa and about 1.0 MPa, and most preferably between about 0.1 MPa and about 0.5 MPa. The T_{g} is preferably between about −100° C. and about −25° C., more preferably between about −100° C. and about −40° C., most preferably between about −100° C. and about −50° C.

The coating 18 preferably has a thickness that is less than about 40 μm, more preferably between about 20 to about 40 μm, most preferably between about 20 to about 30 μm. Intermediate coating 18 is typically applied to the previously coated fiber (either with or without prior curing) and subsequently cured, as will be described in more detail hereinbelow. Various additives that enhance one or more properties of the intermediate coating can also be present, including antioxidants, adhesion promoters, PAG compounds, photosensitizers, carrier surfactants, tackifiers, catalysts, stabilizers, surface agents, and optical brighteners of the types described above.

A number of suitable intermediate coating compositions are disclosed, for example, as “primary coatings” in U.S. Pat. Nos. 6,326,416 to Chien et al., 6,531,522 to Winningham et al., 6,539,152 to Fewkes et al., 6,563,996 to Winningham, 6,869,981 to Fewkes et al., 7,010,206 and 7,221,842 to Baker et al., and 7,423,105 to Winningham, each of which is incorporated herein by reference in its entirety.

Suitable intermediate coating compositions include, without limitation, about 25 to 75 weight percent of one or more urethane acrylate oligomers; about 25 to about 65 weight percent of one or more monofunctional ethylenically unsaturated monomers; about 0 to about 10 weight percent of one or more multifunctional ethylenically unsaturated monomers; about 1 to about 5 weight percent of one or more photoinitiators; about 0.5 to about 1.5 pph of one or more antioxidants; optionally about 0.5 to about 1.5 pph of one or more adhesion promoters; optionally about 0.1 to about 10 pph PAG compound; and about 0.01 to about 0.5 pph of one or more stabilizers.

One preferred class of intermediate coating compositions includes about 52 weight percent polyether urethane acrylate (BR 3741 from Bomar Specialties Company), between about 40 to about 45 weight percent of polyfunctional acrylate monomer (Photomer 4003 or Photomer 4960 from Cognis), between 0 to about 5 weight percent of a monofunctional acrylate monomer (caprolactone acrylate or N-vinylcaprolactam), up to about 1.5 weight percent of a photoinitiator (Irgacure 819 or Irgacure 184 from BASF, LUCIRIN® TPO from BASF, or combination thereof), to which is added about 1 pph antioxidant (Irganox 1035 from BASF), optionally up to about 0.05 pph of an optical brightener (Uvitex OB from BASF), and optionally up to about 0.03 pph stabilizer (pentaerythritol tetrakis(3-mercaptoproprionate) available from Sigma-Aldrich).

An exemplary intermediate coating includes 5 weight percent caprolactone acrylate (Tone M100), 41.5 weight percent ethoxylated (4) nonylphenol acrylate (Photomer 4003), 52 weight percent polyether urethane acrylate oligomer (BR 3741), 1.5 weight percent Irgacure 819, 1.0 pph Irganox 1035, 1.0 pph (3-acryloxypropyl)trimethoxysilane, and 0.032 pph pentaerythritol tetrakis(3-mercaptopropionate). The resulting cured product is characterized by a tensile strength of 0.49 (±0.07) MPa and a Young's modulus at 23° C. of 0.69 (±0.05) MPa.

Coating 20 is the outer coating, and it serves the traditional purpose of a “secondary coating”. The outer coating material 20 is typically the polymerization product of a coating composition that contains urethane acrylate liquids whose molecules become highly cross-linked when polymerized. Outer coating 20 has a high Young's modulus (e.g., greater than about 0.08 GPa at 25° C.) and a high T_{g} (e.g., greater than about 50° C.). The Young's modulus is preferably between about 0.1 GPa and about 8 GPa, more preferably between about 0.5 GPa and about 5 GPa, and most preferably between about 0.5 GPa and about 3 GPa. The T_{g} is preferably between about 50° C. and about 120° C., more preferably between about 50° C. and about 100° C. The coating 20 has a thickness that is less than about 40 μm, more preferably between about 20 to about 40 μm, most preferably between about 20 to about 30 μm.

Other suitable materials for use in outer coating materials, as well as considerations related to selection of these materials, are well known in the art and are described in U.S. Pat. Nos. 4,962,992 and 5,104,433 to Chapin, each of which is hereby incorporated by reference in its entirety. As an alternative to these, high modulus coatings have also been obtained using low oligomer content and low urethane content coating systems, as described in U.S. Pat. Nos. 6,775,451 to Botelho et al., and 6,689,463 to Chou et al., each of which is hereby incorporated by reference in its entirety. In addition, non-reactive oligomer components have been used to achieve high modulus coatings, as described in U.S. Application Publ No. 20070100039 to Schissel et al., which is hereby incorporated by reference in its entirety. Outer coatings are typically applied to the previously coated fiber (either with or without prior curing) and subsequently cured, as will be described in more detail hereinbelow. Various additives that enhance one or more properties of the coating can also be present, including antioxidants, PAG compounds, photosensitizers, catalysts, lubricants, low molecular weight non-crosslinking resins, stabilizers, surfactants, surface agents, slip additives, waxes, micronized-polytetrafluoroethylene, etc. The secondary coating may also include an ink, as is well known in the art.

Suitable outer coating compositions include, without limitation, about 0 to 20 weight percent of one or more urethane acrylate oligomers; about 75 to about 95 weight percent of one or more monofunctional ethylenically unsaturated monomers; about 0 to about 10 weight percent of one or more multifunctional ethylenically unsaturated monomers; about 1 to about 5 weight percent of one or more photoinitiators; and about 0.5 to about 1.5 pph of one or more antioxidants.

Other suitable outer coating compositions include, without limitation, about 10 weight percent of a polyether urethane acrylate oligomer (KWS 4131 from Bomar Specialty Co.), about 72 to about 82 weight percent ethoxylated (4) bisphenol A diacrylate monomer (Photomer 4028 from Cognis), about 5 weight percent bisphenol A diglycidyl diacrylate (Photomer 3016 from Cognis), optionally up to about 10 weight percent of a diacrylate monomer (Photomer 4002 from Cognis) or N-vinylcaprolactam, up to about 3 weight percent of a photoinitiator (Irgacure 184 from BASF, or Lucirin° TPO from BASF, or combination thereof), to which is added about 0.5 pph antioxidant (Irganox 1035 from BASF).

One preferred coating formulation for coating 20 includes 10 weight percent of a polyether urethane acrylate oligomer (KWS 4131), 82 weight percent ethoxylated (4) bisphenol A diacrylate monomer (Photomer 4028), 5 weight percent bisphenol A diglycidyl diacrylate (Photomer 3016), 1.5 weight percent Irgacure 184, 1.5 weight percent Lucirin TPO, and 0.5 pph Irganox 1035.

By virtue of the combination of features described above, the optical fibers of the invention are characterized by an n_{d} value that exceeds the corresponding n_{d} value of an otherwise identical optical fiber that lacks coating 16.

According to one embodiment, the optical fibers of the present invention have an n_{d} value of at least about 25 when measured at 23° C. and 50% humidity.

According to one embodiment, the optical fibers of the present invention have an n_{d} value of at least about 20, more preferably at least about 25, when measured at 35° C. and 90% humidity.

The optical fibers of the present invention can be prepared using conventional draw tower technology for the preparation of the glass fiber and coatings thereof. Briefly, the process for making a coated optical fiber in accordance with the invention involves fabricating glass fiber with its core and cladding having the desired configuration, coating the glass fiber with the initial coating composition (for coating 16), the intermediate coating composition (for coating 18), and the outer coating composition (for coating 20), and then curing all coatings simultaneously. This is known as a wet-on-wet process. Optionally, each subsequently applied coating composition can be applied to the coated fiber either before or after polymerizing the underlying coatings. The polymerization of underlying coatings prior to application of the subsequently applied coatings is known as a wet-on-dry process. When using a wet-on-dry process, additional polymerization steps must be employed.

It is well known to draw glass fibers from a specially prepared, cylindrical preform which has been locally and symmetrically heated to a temperature, e.g., of about 2000° C. As the preform is heated, such as by feeding the preform into and through a furnace, a glass fiber is drawn from the molten material. The primary, intermediate, and secondary coating compositions are applied to the glass fiber after it has been drawn from the preform, preferably immediately after cooling. The coating compositions are then cured to produce the coated optical fiber. The method of curing is preferably carried out by exposing the un-cured coating composition on the glass fiber to ultraviolet light or electron beam. It is frequently advantageous to apply both the several coating compositions in sequence following the draw process. Methods of applying dual layers of coating compositions to a moving glass fiber are disclosed in U.S. Pat. Nos. 4,474,830 to Taylor and 4,851,165 to Rennell et al., each of which is hereby incorporated by reference in its entirety.

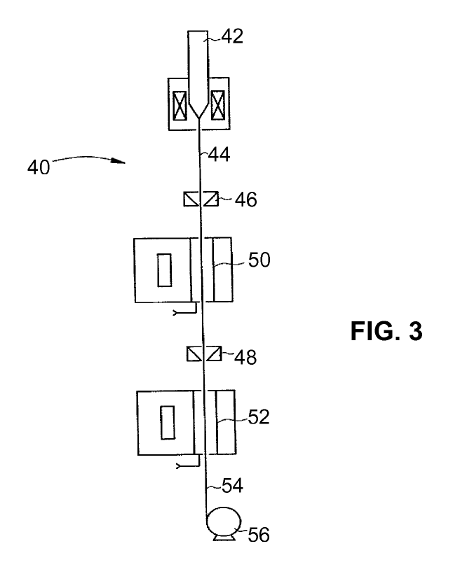

One embodiment of a process for manufacturing a coated optical fiber in accordance with the invention is further illustrated in FIG. 3, generally denoted as 30. As shown, a sintered preform 32 (shown as a partial preform) is drawn into an optical fiber 34. The fiber 34 passes through coating elements 36 and 38, which can include one or more dies that allow for the application of single coating compositions or multiple coating compositions as is known in the art. The dies also adjust the coating thickness to the desired dimension. Preferably, coating 16 is applied to fiber 34 in element 36, and coatings 18 and 20 are applied to fiber 34 in element 38. Curing element 50 is located downstream from element 36 and curing element 52 is located downstream from element 38 to cure the coatings applied to fiber 34. Alternatively, the coatings applied in element 36 may be cured subsequently to fiber 34 passing through element 38. Tractors 56 are used to pull a coated optical fiber 54 through element 52.

As will be appreciated by persons of skill in the art, the system shown in FIG. 3 can be modified to accommodate the application and curing of coatings individually or simultaneously via any combination of the known wet-on-wet or wet-on-dry processes. According to one approach, one or both of the primary and intermediate coatings can be cured prior to application of the outer coating composition. Alternatively, all three coating compositions can be applied to the fiber and then subsequently cured in a single polymerization step.

The optical fibers of the present invention can also be formed into an optical fiber ribbon which contains a plurality of substantially aligned, substantially coplanar optic fibers encapsulated by a matrix material. One exemplary construction of the ribbon is illustrated in FIG. 2, where ribbon 30 is shown to possess twelve optical fibers 10 encapsulated by matrix 32. The matrix material can be made of a single layer or of a composite construction. Suitable matrix materials include polyvinyl chloride or other thermoplastic materials as well as those materials known to be useful as secondary coating materials (generally described above). In one embodiment, the matrix material can be the polymerization product of the composition used to form the outer coating.

Having prepared the optical fiber or fiber ribbons in accordance with the present invention, these materials can be incorporated into a telecommunications system for the transmission of data signals.

### EXAMPLES

The invention will be further clarified by the following examples which are intended to be exemplary of the invention.

### Example 1

### Preparation of Coating Compositions

Two different coating compositions were prepared using a base formulation that was previously known to be useful as a secondary coating composition, which is characterized by a Young's modulus of about 1658.32 (±46.41) MPa, a yield stress of 41.03 (±0.70) MPa, a fracture toughness of about 0.8150 (±0.0853) MPa·m^{1/2}, a ductility of about 395 microns, and a T_{g} of about 55-58° C.

The base formulation for each of these compositions included 10 weight percent of a polyether urethane acrylate oligomer (KWS 4131), 82 weight percent ethoxylated (4) bisphenol A diacrylate monomer (Photomer 4028), 5 weight percent bisphenol A diglycidyl diacrylate (Photomer 3016), 1.5 weight percent Irgacure 184, and 1.5 weight percent Lucirin TPO. To this base formulation, 1.0 pph Irgacure 250 (Composition 1) or 1.0 pph PAG121(BASF) (Composition 2) was added. To both of these coating formulations, 0.5 pph Irganox 1035, 0.2 pph ITX, and 1.0 pph (3-acryloxypropyl)-trimethoxysilane (Gelest) were also added.

The compositions were prepared using commercial blending equipment. The oligomer and monomer components were weighed and then introduced into a heated kettle and blended together at a temperature within the range of from about 50° C. to 65° C. Blending was continued until a homogenous mixture was obtained. Next, the photoinitiators were individually weighed and separately introduced into the homogeneous solution while blending. Any additives were weighed and then introduced into the solution while blending. Blending was continued until a homogeneous solution was again obtained.

The weight percentage of individual components is based on the total weight of the monomers, oligomers, and photoinitiators, which form the base composition. As indicated above, any additives were subsequently introduced into the base composition, as measured in parts per hundred (pph).

### Example 2

### Preparation and Testing of Multimode Optical Fibers

The glass fiber used for this experiment is a multimode fiber with a core diameter greater than 70 μm, and NA greater than 0.24 and an overfilled bandwidth greater than 500 MHz-km at 850 nm. This fiber was coated with Composition 1 or Composition 2, whose thickness was adjusted to about 12.5 μm, and cured using 1 to 3 Fusion UV lamps (Fusion UV Systems, Gaithersberg, Md.) while using a draw speed of at least 5 m/s.

The resulting coated fibers were then coated with an intermediate composition and an outer composition. The intermediate composition included 5 wt % caprolactone acrylate (Tone M100), 41.5 wt % ethoxylated (4) nonylphenol acrylate (Photomer 4003), 52 wt % polyether urethane acrylate oligomer (BR 3741), 1.5 wt % Irgacure 819, 1.0 pph Irganox 1035, 1.0 pph (3-acryloxypropyl)trimethoxysilane, and 0.032 pph pentaerythritol tetrakis(3-mercaptopropionate). The outer composition that included 10 weight percent of a polyether urethane acrylate oligomer (KWS 4131), 82 weight percent ethoxylated (4) bisphenol A diacrylate monomer (Photomer 4028), 5 weight percent bisphenol A diglycidyl diacrylate (Photomer 3016), 1.5 weight percent Irgacure 184, 1.5 weight percent Lucirin TPO, and 0.5 pph Irganox 1035. The intermediate and outer coating compositions were adjusted thicknesses of 32.5 lam and 26 μm, respectively, and cured using 1 to 3 Fusion UV lamps (Fusion UV Systems) while using a draw speed of at least 5 m/s. This resulted in Optical Fiber 1 (including the cured product of Composition 1) and Optical Fiber 2 (including the cured product of Composition 2).

The Optical Fibers 1 and 2 were aged for at least 7 days under various conditions ranging from 50% humidity up to 90% humidity and ambient temperature (−23° C.) up to elevated temperatures of 35° C. or 65° C. Optical Fibers 1 and 2 were subjected to the IEC method for the 2-point bend fatigue test using the four strain rates: 1000 micron/second, 100 micron/second, 10 micron/second, and 1 micron/second. The n_{d} parameter for these optical fibers was calculated from the slope of the curve for each optical fiber under the recited aging conditions. The results obtained are shown in Table 1 below. Example 3 optical fiber was prepared using the same coating compositions as employed in Examples 1 and 2, except that the optical fiber being coated includes an ˜8 weight percent titania outerclad (3 μm) single-mode glass fiber.

TABLE 1
Testing of Optical Fibers for Strength Degradation Resistance

| | n_{d} value | n_{d} value |
|---|---|---|
| Optical Fiber | @ 23 C./50% RH | @ 35 C./90% RH |
| 1 | 26.8 | 25 |
| 2 | 27 | 24.7 |
| 3 | 33.9 | 33.5 |

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. A composition comprising:
a photo-curable base composition comprising one or more acrylate-containing compounds;
a photoinitiator that activates polymerization of the photo-curable base composition upon exposure to light of a suitable wavelength; and
a photo-acid generating compound that liberates an acid group following exposure to said light of the suitable wavelength.

2. The composition according to claim 1, wherein the photoinitiator is a ketonic or phosphine oxide photoinitiator, or a combination thereof.

3. The composition according to claim 1, wherein the photo-acid generating compound is an onium salt, an iron arene complex, or fluoranthene complex.

4. The composition according to claim 1, wherein the photo-acid generating compound is (4-methylphenyl)[4-(2-methylpropyl)phenyl]iodonium PF₆, 8-[2,2,3,3,4,4,5,5-octafluoro-1-(nonafluorobutylsulfonyloxyimino)-pentyl]-fluoranthene, or η⁵-2,4-cyclopentadien-1-yl)[(1,2,3,4,5,6-η)-(1-methyl ethyl)benzene]-iron(+)-hexafluorophosphate.

5. The composition according to claim 1, wherein the photo-acid generating compound is present in an amount of about 0.1 up to about 10 pph.

6. The composition according to claim 5, wherein the photo-acid generating compound is present in an amount of about 0.5 up to about 8 pph.

7. The composition according to claim 5, wherein the photo-acid generating compound is present in an amount of about 1 up to about 7 pph.

8. The composition according to claim 1, wherein the composition further comprises one or more additives selected from the group of adhesion promoters, photosensitizers, antioxidants, carriers, tackifiers, reactive diluents, catalysts, and stabilizers.

9. The composition according to claim 1, wherein the base formulation further comprises one or more urethanes, acrylamides, N-vinyl amides, styrenes, vinyl esters, and combinations thereof.

10. The composition according to claim 1, wherein the base formulation is substantially free of compounds having an epoxy group.

11. An optical fiber comprising a glass fiber and a coating formed of a composition according to claim 1 that substantially encapsulates the glass fiber.

12. The optical fiber according to claim 11, wherein the glass fiber comprises a core and a cladding, wherein the cladding comprises silica or a blend of silica and titania.

13. The optical fiber according to claim 11, wherein the coating has a thickness that is less than about 20 μm.

14. The optical fiber according to claim 11, wherein the fiber further comprises an intermediate coating having a Young's modulus of not more than about 3 MPa and an outer coating having a Young modulus of not less than about 600 MPa.

15. The optical fiber according to claim 11, wherein the fiber has an increased n_{d} value, as measured by a dynamic fatigue test method, in comparison to an otherwise identical fiber that lacks the coating.

16. The optical fiber according to claim 15, wherein the optical fiber has an n_{d} value that is at least about 25 at 23° C. and 50% humidity.

17. The optical fiber according to claim 15, wherein the optical fiber has an n_{d} value that is at least 20 at 35° C. and 90% relative humidity.

18. The optical fiber according to claim 15, wherein the optical fiber has an n_{d} value that is at least 25 at 35° C. and 90% relative humidity.

19. An optical fiber ribbon comprising a plurality of optical fibers according to claim 11.
